(19) United States
(12) Patent Application Publication
(10) Pub. No.: US 2018/0112943 A1
(43) Pub. Date: Apr. 26, 2018

(54) ACCESSORY AND METHOD FOR UNLOCKING A METAL LOCKING MECHANISM IN A FIREARM

(71) Applicant: Derek Edward Kealoha, FONTANA, CA (US)

(72) Inventor: Derek Edward Kealoha, FONTANA, CA (US)

(21) Appl. No.: 15/333,132

(22) Filed: Oct. 24, 2016

(51) Int. Cl. F41A 17/38; H01F 7/02

(52) U.S. Cl. CPC F41A 17/38; H01F 7/0231

(57) ABSTRACT

A device and method for unlocking the magazine of a firearm employing a steel catch, bullet button or other in and out metal magazine locking mechanism is shown. The device comprises a magnet affixed to a wristband, ring or glove worn preferably on the underside of the hand or wrist of the non-primary arm. While the primary hand is gripping the firearm, the user swipes the area of the non-primary hand that contains the magnet across the magazine catch, bullet button or other metal in and out metal magazine locking mechanism, whereby the magnet temporarily attaches to the magazine catch to pull the in and out metal magazine locking mechanism away from and/or out of the magazine well so that the magazine slides out from the magazine well. Thereafter, the non-primary hand can insert another magazine into the now empty magazine well.

### RELATED APPLICATION

This application claims the benefit of U.S. Provisional Application No. 62246245 filed on Oct. 26, 2015 and U.S. Provisional Application No. 62246249 filed on Oct. 26, 2015, the entire disclosures of which are incorporated herein by reference.

### FIELD OF THE INVENTION

This invention relates to an accessory for rifles or other firearms that contain a steel magazine catch and/or bullet button or other integral locking mechanisms that moves in and out of the magazine well of the rifle which lock a magazine in place.

### BACKGROUND OF THE INVENTION

Many rifles and other firearms have a locking mechanism such as magazine catch that moves in and out of the magazine well of that firearm to hold the magazine in place. The magazine catch locks the magazine in place so when you push the magazine release button, it moves the magazine catch out of the body of the rifle allowing the magazine to fall free of the magazine well and away from the rifle. Likewise, the bullet buttons accessory, locks the magazine in place so that the magazine cannot be removed from the magazine well without the use of a tool, such as the head of a bullet, a spike or another tool. In such firearms containing magazine locking mechanisms, when a magazine needs to be replaced, it may require both hands to unlock the magazine catch or other locking mechanism to remove the magazine. One hand may be needed to hold the rifle (usually the non-dominant hand) while the other hand (usually the dominant hand) pulls out the magazine catch or uses a tool to unlock the locking mechanism to release the magazine from the magazine well. This method can be cumbersome as the user may have to stop and switch hands to us a tool. Allowing the locking mechanism to be disengaged and remove the magazine.

Some jurisdictions such as the State of California ban AR-style rifles with magazines that easily can be removed without the aid of a tool so that the magazines cannot be reloaded quickly and easily. One example accessory that can be installed in a semiautomatic rifle to comply with this ban is a bullet button, which is an accessory that replaces the rifle's standard magazine release button and is attached to the magazine catch. A bullet button forces the user to remove the magazine by using a tool instead of just a finger. Bullet buttons stop exhausted magazines from being reloaded quickly and prevent quick changes of magazines. The bullet button is recessed in a small hole on an AR-style rifle located next to the magazine well. The bullet button only can be engaged and released by using another device, such as the tip of a bullet, or a spike. It is either an aftermarket accessory, or incorporated directly in manufactured weapons and sold in states with laws against marketing and selling AR style rifles with easily removable magazines.

The bullet button's popularity has given rise to a new class of accessories. Examples of such prior art accessories are rings and gloves having a small spike protruding from a finger that presses the bullet button to unlock the magazine. Another prior art accessory is a magnet that is placed directly on top of the recessed magazine bullet button release so the user can quickly remove the magazine with their hand. However, in states that require locks, while it may be legal to purchase it, the magnet cannot be left on a rifle. It is in violation of California's assault weapon's ban to leave the tool attached to the fire arm.

### SUMMARY OF THE INVENTION

In a preferred embodiment of the present invention, an accessory for a firearm that employs any type of steel catch that holds a magazine in place is shown having a magnet which is temporarily attached to a user. In a preferred embodiment of the present invention, a magnet is permanently affixed to a wristband. In an alternate preferred embodiment, the magnet is affixed to the underside of a wristband. In an alternate embodiment, the magnet is permanent affixed to a ring. In yet a further embodiment, a magnet is affixed to a glove. In a preferred embodiment, a magnet is permanently affixed to the underside of glove or a bracelet proximate the wrist.

In a preferred method of the present invention, a user of the firearm having a steel catch, bullet button or other in and out metal magazine locking mechanism wears the invention on his/her non-primary hand or support hand. While the primary hand is gripping the firearm, the user swipes the area of the non-primary hand that contains the magnet across the magazine catch or other metal in and out metal magazine locking mechanism, whereby the magnet temporarily attaches to the magazine catch to pull the in and out metal magazine locking mechanism away from and/or out of the magazine well. This engages the locking mechanism so that it unlatches the magazine from the magazine well. Once unlatched, so long as the magazine is not permanently locked in the magazine well or temporarily or permanently jammed therein, the magazine slides out from the magazine well. Thereafter, the non-primary hand can insert another magazine into the now empty magazine well until it is locked in place.

### BRIEF DESCRIPTION OF THE DRAWINGS

FIG. 1 is a perspective view of a preferred embodiment of the device of the present invention.

FIG. 2 is a top plan view of a preferred embodiment of the device of the present invention as it is worn on the wrist of the user.

FIG. 3 is a cross section of a preferred embodiment of a housing containing a magnet of the present invention.

FIG. 4 is a diagram showing how a preferred embodiment of the device of the present invention is used.

FIG. 5 is a diagram showing what happens as a preferred embodiment of the device of the present invention is used so as to pull the magazine catch away from the magazine well to disengage the locking mechanism so that the magazine will slide out of the magazine well.

FIG. 6 is a cross section showing a loaded magazine in the magazine well of a firearm with the magazine locking mechanism engaged.

FIG. 7 is a cross section showing the magazine locking mechanism as it is disengaged by a preferred embodiment of the present invention such that the magazine is no longer locked within the magazine well.

### DETAILED DESCRIPTION OF THE DRAWINGS.

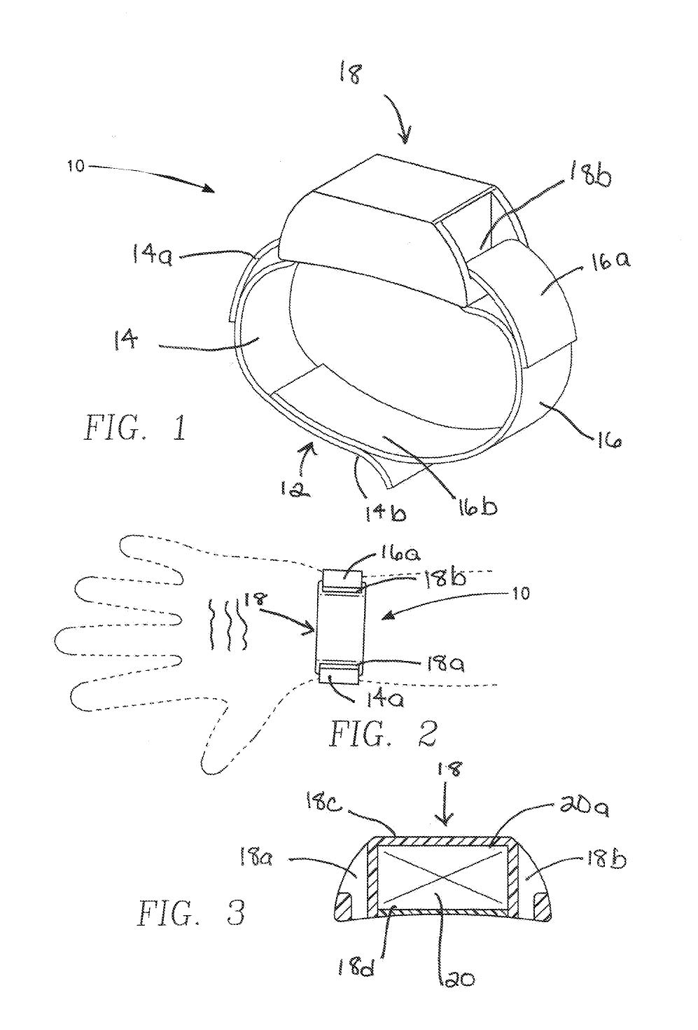

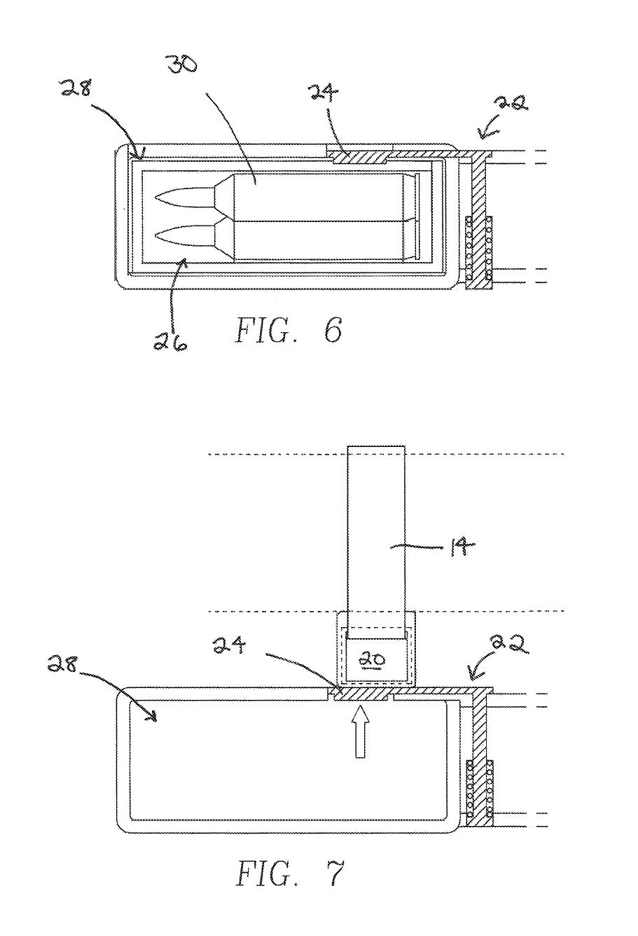

Referring first to FIGS. 1-7, a preferred embodiment of the device 10 of the present invention is shown. The device 10 is an accessory that is used with firearms that contain removable magazines (such as magazine 26 shown in FIGS. 5 and 6) which may be locked into place by a steel or hard metal magazine catch, bullet button or other metal in and out locking mechanism 22 (shown in FIGS. 5 through 7) which has a metal latch 24 (shown in FIGS. 6 and 7) that engages the magazine 26 in the magazine well 28 so that it will not fall out of the firearm. The magazine 26 is the part of the firearm that moves bullet cartridges 30 (shown in FIG. 6) stored in the magazine 26 into a position where they may be loaded into the chamber by the action of the firearm.

Referring more specifically to FIG. 1-3, a preferred embodiment of the device 10 of the present invention comprises a bracelet 12 and a magnet 20 (shown in FIG. 3) fully encased in a housing 18 that is attached to the bracelet 12. In a preferred embodiment bracelet 12 comprises two strips of material, leather, plastic or other pliable bendable material or watch links and the like, that is capable of being removably worn around the wrist of the firearm user. As shown in the embodiment shown in FIG. 1, the bracelet 12 is comprised of two straps 14 and 16, which have ends 14a and 14b, and 16a and 16b, respectively. On the underside of ends 14a and 16a, there is hook or loop material (not shown) which corresponds to hook and loop material located on straps 14 and 16 (not shown) so that the strap can be sized to fit the user and lock into place. On the opposite ends of straps 14 and 16, there is also hook and loop material (not shown) so that ends 14b and 16b can be securely fastened together to hold the bracelet together on the user. In an alternate embodiment, the straps may be permanently affixed to housing 18. In yet a further alternate embodiment, the straps 14 and 16 may be attached to each other by a buckle (not shown). In another alternate embodiment, the housing may be attached to a flexible link bracelet so that it may be worn around the wrist of the user. Thus, any means of removably affixing the housing 18 to the user, may be used.

In a preferred embodiment, the housing 18 is ABS plastic but any non-conductive material may be used to encase the magnet 20 (shown in FIG. 3). The housing 18 in a preferred embodiment is essentially a rounded trapezoidal shape comprising two outer slots 18a and 18b on each of the elongated sides of housing 18 that are capable of receiving the ends 14a and 16a of straps 14 and 16, respectively of bracelet 12. In alternate embodiments, not shown, the housing 18 may be any shape that is capable of enclosing the magnet 20 and easily adhering to a bracelet 12, glove (not shown), ring (not shown) or other object that can be worn on the arm of the user, or a necklace of sufficient length.

Referring next to FIG. 2, a plan view of a preferred embodiment 10 of the present invention is shown as it is worn on the wrist of the user. In a preferred embodiment, the device 10 is worn on the underside of the wrist so that the housing 18 rests against the underside of the wrist and extends outward therefrom.

Referring next to FIG. 3, a cross section of a preferred embodiment of the housing 18 of the present invention is shown as the crosshatched portions that surround a magnet 20. Slots 18a and 18b are holes created to receive strap ends 14a and 16a of the bracelet 12, not shown. As can be seen in FIG. 3, in a preferred embodiment, a magnet 20 is fully encased within the housing 18, however, with suitable modifications, not shown, the magnet 20 may be fully exposed along its top surface 20a or otherwise partially encased in housing 18. In a preferred embodiment, there are no ejection or injection mold points rising above the top surface 18c thereof. In a preferred embodiment, on the inside of the housing 18, shown partially in FIG. 3, the bottom portion 18d of the housing contains an area on which the magnet 20 sits.

In a preferred embodiment, the magnet 20 is comprised of Neodymium (NdFeB), Grade N52. In a preferred embodiment, the magnet is approximately 1″ long×0.5″ wide×0.5″ thick and is magnetized throughout its thickness. However, any high magnetic energy permanent magnet (having a high resistance to being demagnetized) that is capable of moving a metal locking mechanism from within a magazine to unlock it from the magazine well may be used.

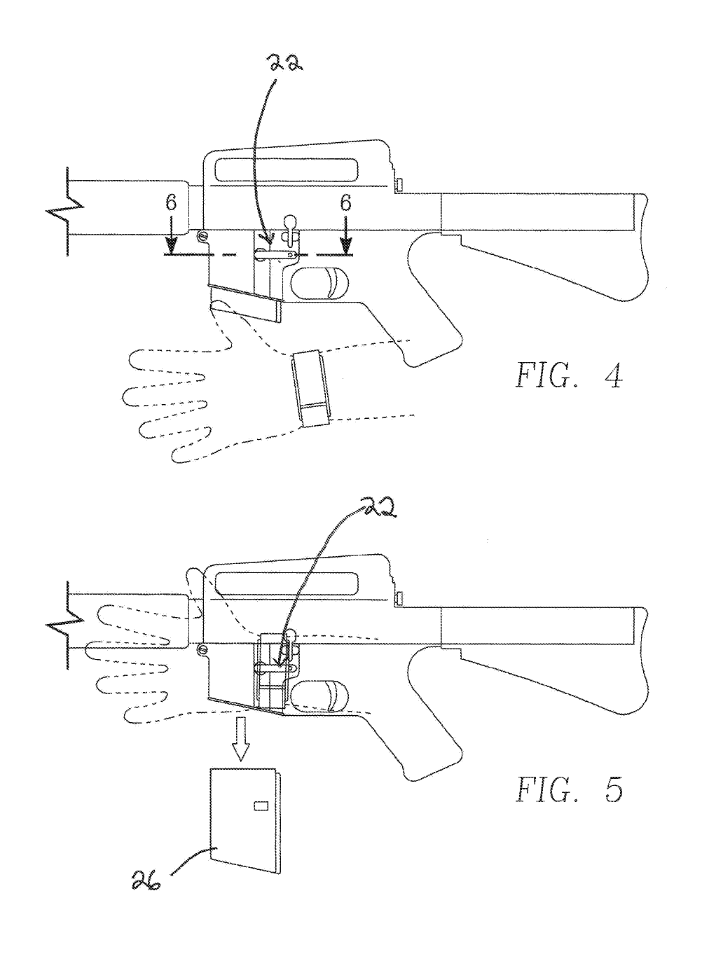

Referring next to FIGS. 4-7, a preferred method of the present invention is shown. In a preferred method of the present invention as shown in FIG. 4, the firearm user wears the device 10 of the present invention on the wrist of his/her non-primary hand (shown by dotted lines in the drawing). While the primary hand is gripping the firearm (not shown), the user swipes (i.e. moves it over) the area of the non-primary hand on which the housing 18 containing a magnet 20 is being worn across the magazine locking mechanism 22 (which, for purposes of illustration and not limitation is shown as a magazine catch in FIGS. 4-7) whereby, as shown in FIG. 5, the magnet 20 temporarily attaches to the latch portion 24 of the locking mechanism 22 (the latch 26 being shown in a locked position in FIG. 6) so as to pull the latch 24 of the locking mechanism 22 out of the magazine 26 as shown in FIG. 7 to unlock the magazine 26 so that it is released and falls out of magazine well 28, so long as the magazine 26 is not permanently locked within the magazine well 28 or temporarily or permanently jammed therein. Thereafter, the non-primary hand can insert another magazine into the now empty magazine well.

By using the device of the present invention, the magnet will never become affixed to the locking mechanism 22 so as to violate certain laws that precludes same.

While particular embodiments and methods of the present invention have been shown and illustrated herein, it will be understood that many changes, substitutions and modifications may be made by those persons skilled in the art. It will be appreciated from the above description of presently preferred embodiments and methods that other configurations and techniques are possible and within the scope of the present invention. Thus, the present invention is not intended to be limited to the particular embodiment and methods specifically discussed here in above.

What is claimed is:

1. A device for use with firearms having a metal locking mechanism that goes in and out of the magazine well for temporarily locking a magazine in place, comprising:
a magnet strong enough to move the metal locking mechanism out from the magazine and/or magazine well in order to release it, and
an attachment means for attaching the magnet to the user.

2. The device of claim 1 further comprising
a housing enclosing the magnet which is attached to the attachment means.

3. The device of claim 1, wherein the magnet is comprised of Neodymium and/or other such material.

4. The device of claim 1, wherein the magnet comprises any high magnetic energy permanent or non-permanent magnet capable of moving the metal locking mechanism from within the magazine and/or magazine well to unlock the magazine.

5. The device of claim 1, wherein the means to attach the device to a user comprises a glove.

6. The device of claim 1 wherein the means to attach is a bracelet.

7. The device of claim 1 wherein the means to attach is a ring.

8. The device of claim 1 wherein the magnet is attached to the user so that the magnet is worn on the underside of the user's wrist or hand.

9. The device of claim 1 whereby the magnet will not become affixed to the locking mechanism.

10. A method for unlocking a magazine locking mechanism that moves in and out of a firearm magazine to temporarily lock the magazine in place within the firearm and having a latch which fits within the magazine to lock it and which must be unlocked to remove the magazine, comprising the steps of:
wearing a device containing a magnet that is temporarily attached to the wrist of the user's non-primary hand, whereby the magnet is strong enough to dislodge the latch of the magazine locking mechanism so that the magazine can be unlocked,
swiping the magnet across the latch area of the magazine locking mechanism, whereby the magnet pulls the latch of the locking mechanism out of the magazine to unlock the magazine so that it can come out of magazine well.

11. The method of claim 10, whereby the magnet is worn on the underside of the wrist of the user.

12. The method of claim 10, whereby the magnet comprises any high magnetic energy permanent magnet capable of moving the metal locking mechanism from within the magazine to unlock the magazine.

13. The method of claim 10 whereby the magnet is comprised of Neodymium.

14. The method of claim 10, wherein the magnet is encased in a housing attached to a bracelet allowing the user to wear the magnet on the user's wrist.

15. The method of claim 10, wherein the magnet is encased in a housing attached to the underside of a glove allowing the user to wear the magnet on the underside of the user's wrist.
